(19) United States
(12) Patent Application Publication
(10) Pub. No.: US 2021/0198456 A1
(43) Pub. Date: Jul. 1, 2021

(54) RUBBER COMPOSITION AND A PNEUMATIC TIRE

(71) Applicant: TOYO TIRE Corporation, Itami-shi (JP)

(72) Inventor: Shinya Hasegawa, Itami-shi (JP)

(73) Assignee: TOYO TIRE Corporation, Itami-shi (JP)

(21) Appl. No.: 17/130,436

(22) Filed: Dec. 22, 2020

(30) Foreign Application Priority Data
Dec. 25, 2019 (JP) 2019-234244

(51) Int. Cl. C08L 7/00; B60C 1/00; C09D 107/00

(52) U.S. Cl. CPC C08L 7/00; B60C 1/0041; B60C 2001/005; B60C 2001/0066; C09D 107/00

(57) ABSTRACT

The present invention provides a rubber composition having reduced its odor, which can show a durability improvement effect, as well as to provide a pneumatic tire including the rubber for coating steel cords which is superior in its durability. The objectives above can be solved by providing a rubber composition, including a rubber component a filler, a vulcanization agent, a vulcanization accelerator, and a resorcinol resin, in which the resorcinol resin includes a cresol residue at a content of 0.2 mass % or less, as well as providing a pneumatic tire which has been obtained by vulcanizing the rubber composition, and in particular providing a pneumatic tire in which the rubber is a rubber for coating steel cords.

### TECHNICAL FIELD

The present invention relates to a rubber composition which has reduced its odor, and a pneumatic tire including a rubber for coating of steel cords that is excellent in its durability, which has been formed by vulcanizing the rubber composition.

### BACKGROUND OF THE INVENTION

In the field of pneumatic tires or particularly in the field of radial tires, steel cords are largely used as a reinforcing material in the belt layers of the tires for passenger cars, or in the belts, the carcasses and the chafer layers of large size tires for trucks and buses. In association with prolonging the period of service of these tires, it has been considered important to enhance the reinforcement effects by the steel cords, thereby maintaining the durability for the period of service of the tires for a long term. For example, a rubber composition for coating of steel cords is required to have a good adhesive property with the steel cords.

Patent Reference No. 1 discloses a rubber composition including a co-condensation product including a structural unit derived from p-tert-butyl phenol, a structural unit derived from o-phenyl phenol and a structural unit derived from resorcinol, which has a softening point of 150 degrees Celsius or less.

Also, Patent Reference No. 2 discloses a rubber composition including powders of a porous carbide from plants having an average particle size of 10 to 500 μm, and at least one resin selected from the group consisting of a cresol formaldehyde condensation resin, a resorcinol condensation product, and a denatured resorcinol condensation product.

### PRIOR ART REFERENCES

### Patent References

Patent Reference No. 1: Japanese Patent No. 5865544

Patent Reference No. 2: Japanese Laid-Open Patent Publication No. 2011-162626

### SUMMARY OF THE INVENTION

### The Objectives to be Solved by the Invention

The inventor of the present inventor has zealously considered and found that the rubber compositions disclosed in the Patent References mentioned above have strong odor, and when used as raw material of a rubber for coating steel cords, they still have a room for further improvement in its durability.

The present invention has been accomplished by considering the circumstances as explained above, and its purpose is to provide a rubber composition having reduced its odor, which can show a durability improvement effect, as well as to provide a pneumatic tire including the rubber for coating of steel cords which is superior in its durability.

### Means to Solve the Problem

It is noted that a resorcinol resin is generally known as an agent having a strong odor, and that it has been demanded to reduce the odor from the resorcinol resin particularly in the manufacturing process of a rubber composition. The inventor of the present invention has zealously examined in order to solve the objective above, and found that a cresol residue in the resorcinol resin is the cause of the odor, and that the odor of the resorcinol resin can be significantly reduced if a content of the cresol residue of the resorcinol is 0.2 mass % or less, and furthermore, that the durability of the rubber for coating of steel cords particularly can be improved when by using the resorcinol resin as a raw material. In details, the present invention is provided with the following structure.

That is, the present invention relates to a rubber composition, including a rubber component, a filler, a vulcanization agent, a vulcanization accelerator, and a resorcinol resin, in which the rubber composition includes a cresol residue in the resorcinol resin at a content of 0.2 mass % or less.

In the rubber composition above, it is preferable that the vulcanization accelerator is a sulfenamide type vulcanization accelerator.

In addition, the present invention relates to a pneumatic tire which has been obtained by vulcanizing the rubber composition, and in particular relates to a pneumatic tire in which the rubber is a rubber for coating steel cords.

### Effects of the Invention

The rubber composition of the present invention has reduced its odor and a vulcanized rubber therefrom is excellent in an improved durability. Therefore, a pneumatic tire including the rubber for coating of steel cords obtained by vulcanizing the rubber composition is excellent in the reinforcement property of the rubber for coating as well as is excellent in the peeling resistance between the rubber for coating and the steel cords.

### Embodiments to Carry Out the Invention

The rubber composition of the present invention includes a rubber component, a filler, vulcanization agent and resorcinol resin.

As the rubber component, for example, a diene type rubber can be suitably used. The examples of the diene type rubber can include natural rubber (NR), isoprene rubber (IR), butadiene rubber (BR), styrene butadiene rubber (SBR), acrylonitrile butadiene rubber (NBR), chloroprene rubber (CR), styrene isoprene copolymer rubber, butadiene isoprene copolymer, and styrene isoprene butadiene copolymer rubber, etc. These can be used alone or in combination of two or more kinds thereof. As the diene type rubber, it is preferable to use natural rubber, isoprene rubber, butadiene rubber, or styrene butadiene rubber, or a blend of two or more kinds thereof.

It is preferable that the rubber composition of the present invention includes carbon black a filler. The examples of the carbon black to be used can include carbon black such as SAF, ISAF, HAF, FEF and GPF, etc., and a conductive carbon black such as acetylene black and ketjen black, etc, which can be used in the rubber industries. In the rubber composition of the present invention, it is preferable to blend a carbon black at an amount of 30 to 90 parts by mass, and more preferable to blend it at an amount of 50 to 65 parts by mass, with respect to 100 parts by mass of the rubber component.

Also, it is preferable to include silica as a filler. The examples of the silica to be used can include wet process silica, dry process silica, sol-gel silica, and surface treated silica, etc, which can be used in the rubber industries. In particular, it is preferable to use wet process silica. Regarding the blending amount of the silica, it is preferable to blend it at an amount of 0 to 15 parts by mass, and more preferable to blend it at an amount of 5 to 10 parts by mass, with respect to 100 parts by mass of the rubber component.

When silica is included as a filler, it is preferable to additionally include a silane coupling agent. The silane coupling agent to be used can include sulfur in its molecule, and for example, it can be of various silane coupling agents which can be blended together with silica in a rubber composition. For example, the examples thereof can include; a sulfide silane such as bis(3-triethoxysilylpropyl) tetrasulfide (for example, “Si69” manufactured by Degussa AG Corporation), bis(3-triethoxysilylpropyl) disulfide (for example, “Si75” manufactured by Degussa AG Corporation), bis(2-triethoxysilylethyl) tetrasulfide, bis (4-triethoxysilylbutyl) disulfide, bis(3-trimethoxysilylpropyl) tetrasulfide, and bis(2-trimethoxysilylethyl) disulfide; and a protected mercaptosilane such as γ-mercaptopropyl trimethoxy silane, γ-mercaptopropyl triethoxy silane, mercaptopropylmethyl dimethoxy silane, mercaptopropyl dimethyl methoxysilane, a mercaptosilane such as mercaptoethyl triethoxy silane, 3-octanoylthio-1-propyl triethoxy silane and 3-propionylthio propyl trimethoxy silane. A blending amount of the silane coupling agent can be 0.5 to 15.0 mass % with respect to 100 mass % of a silica total amount.

As the vulcanization agent, sulfur can be preferably used. The sulfur can be for rubber applications, and the examples thereof to be used can include powdery sulfur, sedimentation sulfur, insoluble sulfur, high dispersibility sulfur, etc. In considering the rubber properties and the durability after the vulcanization, the blending amount of the sulfur can be preferably 1.0 to 10.0 parts by mass, and more preferably 4.0 to 7.0 parts by mass, with respect to 100 parts by mass of the rubber component.

The examples of the vulcanization accelerator to be used can include a sulfenamide type vulcanization accelerator, a thiram type vulcanization accelerator, a thiazole type vulcanization accelerator, a thiourea type vulcanization accelerator, a guanidine type vulcanization accelerator, and a dithiocarbamate type vulcanization accelerator, etc., which can be used in the rubber industries, and each of which can be used alone or in appropriate combination thereof. In particular, in view of making it excellent in the reinforcement property of the vulcanized rubber as well as is excellent in the peeling resistance between the rubber for coating and the steel cords in the present invention, it is preferable to use a sulfenamide type vulcanization accelerator. The blending amount of the vulcanization accelerator can be preferably 0.3 to 3.0 parts by mass, and more preferably 0.5 to 1.5 parts by mass, with respect to 100 parts by mass of the rubber component.

The example of the resorcinol resin can a compound in which at least one kind selected from the group consisting of a resorcinol and an alkyl derivative thereof is condensed with an aldehyde such as formaldehyde, which can be used along with additional monomer component such as an alkyl phenol. Specifically, the example thereof can include: a resorcinol formaldehyde resin which is a condensation of a resorcinol and formaldehyde; and a resorcinol alkyl phenol condensation formaldehyde resin in which a resorcinol and an alkyl phenol such as cresol are condensed with formaldehyde.

In addition, the resorcinol resin used in the present invention is designed to include a cresol residue at a content of 0.2 mass % or less. As a result, the odor of the resorcinol resin can be significantly reduced. In more details, it is preferable that the resorcinol resin to be used in the present invention includes a cresol residue at a content of 0.1 mass % or less, and more preferably at a content of 0.05 mass % or less. In addition, the lower limit of the cresol residue included in the resorcinol resin can be preferably 0.03 mass %, and more preferably, 0.01 mass %, and yet more preferably 0.001 mass %, and further more preferably zero. In addition, in view of reducing the odor, and furthermore in view of making the vulcanized rubber excellent in the reinforcement property and improving the peeling resistance between the rubber for coating and the steel cords, it is preferable to use the resorcinol resin having the structural unit derived from a styrenated resorcinol represented by formula (1) below.

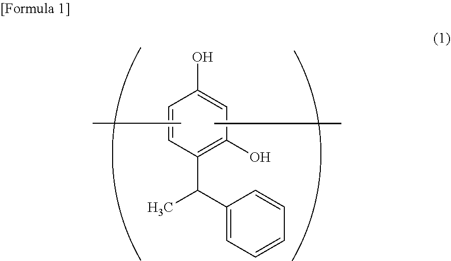

In view of improving a reinforcement property of the vulcanized rubber and a peeling resistance between the rubber for coating and the steel cords, it is preferable that a ratio of the structural unit derived from a styrenated resorcinol represented by formula (1) included in the resorcinol resin used in the present invention can be preferably 60.0 to 70.0 mol %.

The blending amount of the resorcinol resin can be preferably 0.1 to 5.0 parts by mass, and more preferably 0.5 to 3.0 parts by mass, with respect to 100 parts by mass of the rubber component.

In addition to the rubber component, the filler, the vulcanization agent, the vulcanization accelerator and the resorcinol resin, the rubber composition of the present invention can include an antioxidant, stearic acid, a softener such as wax and oil, and a processing aid, etc.

As one embodiment of the present application, the rubber composition, the rubber component, and/or the resorcinol resin may or may not include a structural unit derived from p-tert-butyl phenol and/or a structural unit derived from o-phenyl phenol.

As another embodiment of the present application, the rubber composition of the present invention may or may not include powders of a porous carbide from plants (for example, bamboo charcoal and charcoal, etc.) having an average particle size of 10 to 500 μm

The examples of the antioxidant can include an aromatic amine type antioxidant, an amine ketone type antioxidant, a monophenol type antioxidant, a bisphenol type antioxidant, a polyphenol type antioxidant, a dithiocarbamate type antioxidant, and a thiourea type antioxidant, etc., which are used in the rubber industries, one of which can be used alone or in appropriate combination thereof. It is preferable that a content of the antioxidant is 0.5 to 10 parts by mass with respect to 100 parts by mass of the rubber component.

The rubber composition of the present invention can be obtained by kneading a rubber component, a filler, a vulcanization agent, a vulcanization accelerator, and a resorcinol resin, along with an antioxidant, stearic acid, a softener such as wax and oil, and a processing aide, etc., if necessary, by means of a blending kneader such as a Banbury Mixer, a kneader or a roll, which is used in the rubber industry.

Also, a blending method of the components as mentioned above can be carried out by providing in advance a master batch by blending and kneading the blending components except for vulcanization type agents such as a vulcanization agent and a vulcanization accelerator, followed by adding the remaining components therein to continue further kneading; or alternatively, it can be carried out by adding all the components at the same time to knead them.

### EXAMPLES

Hereinafter, the examples of the present invention are explained.

### Preparation of Rubber Composition

In accordance with the blending prescription shown in Table 1, each of the rubber compositions of Examples 1 to 4 and Comparative Example 1 was blended, which was kneaded by using a Banbury Mixer to obtain a rubber composition. The agents in Table 1 are explained below. In Table 1, the blending amount of each agent is based on parts by mass with respect to 100 parts by mass of the rubber component.

a) The “natural rubber” (NR) is RSS #3.
b) The “carbon black” is a commercial name, “SEAST 300,” manufactured by Tokai Carbon Co., Ltd.
c) The “silica” is a commercial name “ULTRASIL VN3” manufactured by Evonik Industries AG.
d) The “zinc oxide” is the third type of zinc oxide manufactured by Mitsui Mining And Smelting Company.
e) The “stearic acid” is stearic acid in beads manufactured by NOF Corp.
f) The “antioxidant” is NOCRAC 6C manufactured by Ouchi Shinko Chemical Industrial Co., Ltd.
g) The “resorcinol resin (1)” a commercial name “SUMIKANOL 620” manufactured by Sumitomo Chemical Co., Ltd., which includes a cresol residue at an amount of 4.0 mass %.
h) The “resorcinol resin (2)” is a resorcinol resin having a structural unit derived from a styrenated resorcinol represented by formula (1) as explained above, which includes a cresol residue at an amount of 0.03 mas %, whose commercial name is “B20S” manufactured by Techno Waxchem Pvt. Ltd.
i) The “hexamethoxymethyl melamine” is a commercial name “CYLETS 963L” manufactured by Allnex Japan Corporation.
j) The “stearic acid cobalt” is a commercial name “COREBOND CS-9.5” manufactured by Taekwang Fine Chemical Co. Ltd.
k) The “sulfur” is a commercial name “MUCRON OT-20” manufactured by Shikoku Chemicals Corporation.
l) The vulcanization accelerator, “DCBS” is N, N-dicyclohexyl-2-benzothiazolyl sulfenamide, whose commercial name is “NOCCELER DZ-G” manufactured by Ouchi Shinko Chemical Industry Corporation.
m) The vulcanization accelerator “TBBS” is N-tert-butyl-2-benzothiazole sulfenamide, whose commercial name is “SUNCELER NS-G”, manufactured by Sanshin Chemical Industry Co., Ltd.

The amount of the cresol residue included the resorcinol resin of the agent was measured by collecting 10 mg of a resorcinol resin sample, followed by dissolving it in 10 mL of a solvent, to measure it by means of a gas chromatography (GC). The measurement conditions are explained below.

The solvent: Acetone including DBP (DBP 0.1 mg/ml);
The column: HP-5;
The GC Apparatus: GC-2010 manufactured by Shimadzu Corporation; and
The Calibration curve: m-cresol at three points (0.01 mg, 1 mg and 5 mg).

The calibration curve was prepared based on the area ratio of DBP to m-cresol.

The rubber compositions thus obtained above was then vulcanized, followed by evaluating them in accordance with the following conditions.

### (1) Evaluation of Odor

The evaluation of odor was carried out in accordance with JIS Z9080. An odor bag of a 5 L polyethylene terephthalate was charged with 100 g of a molded sheet and an air having passed through an activated carbon, followed by leaving it at a room temperature of 60 degrees Celsius for two hours. Then, five panelists evaluated the air in the odor bag to classify it into one of six categories (i.e., to 6). The average of the results by the five panelists was calculated. As the number becomes higher, it means it had a stronger odor.

1: No feeling of the odor at all.
2: Very slight feeling of the odor.
3: Weak feeling of the odor.
4: Clear feeling of the odor.
5: Strong feeling of the odor.
6: Very strong feeling of the odor.

### (2) Vulcanized Rubber Reinforcement Property

In accordance with JIS K6251, a tensile test (a dumbbell shape No. 3) was carried out to measure a break strength (TS) and a break elongation (EB), and a product of these values (TS×EB) was assumed to be a tension product. It was shown by an index, assuming that a value of Comparative Example 1 was 100. As the numerical value becomes larger, it means that the reinforcement property becomes more superior.

### (3) Peeling Resistance in a Humid, Heated and Aging Condition

The rubber composition was made sheeting to provide a rubber sheet having a thickness of 1.0 mm. Twelve steel cords, each having a brass plating (structure: 3×0.20 mm+6×0.35 mm), were aligned as a layer with an intervention of 25 mm with each other, which was sandwiched by two sheets of the rubber sheets, two of which were laminated, thereby obtaining an unvulcanized complex including two layers of the steel cords.

The unvulcanized complex thus obtained was vulcanized at 150 degrees Celsius for 30 minutes to obtain a test piece The test piece was left in a saturated steam condition at 105 degrees Celsius for 96 hours, followed by carrying out a peeling test between the two layers of the steel cords by using an autograph (DCS500 manufactured by Shimadzu Corporation) to evaluate a peeling resistance. It was shown by an index, assuming that a value of Comparative Example 1 was 100. As the numerical value becomes larger, it means that the peeling resistance becomes more superior.

TABLE 1

| | Comp. 1 | Ex. 1 | Ex. 2 | Ex. 3 | Ex. 4 |
|---|---|---|---|---|---|
| natural rubber | 100 | 100 | 100 | 100 | 100 |
| carbon black | 60 | 60 | 60 | 60 | 60 |
| silica | — | — | — | 5 | — |
| zinc oxide | 8 | 8 | 8 | 8 | 8 |
| stearic acid | 1 | 1 | 1 | 1 | 1 |
| antioxidant | 2 | 2 | 2 | 2 | 2 |
| resorcinol resin | 2 | — | — | — | — |
| (1) | | | | | |
| resorcinol resin | — | 2 | 2 | 2 | 2.5 |
| (2) | | | | | |
| hexamethoxymethyl | 2 | 2 | 2 | 2 | 2 |
| melamin | | | | | |
| stearic acid | 2 | 2 | 2 | 2 | 2 |
| cobalt | | | | | |
| sulfur | 6 | 6 | 6 | 6 | 6 |
| DCBS | 1 | 1 | — | 1 | 1 |
| TBBS | — | — | 1 | — | — |
| Evaluation Of | 5 | 2 | 2 | 2 | 2 |
| Odor | | | | | |
| Vulcanized Rubber | 100 | 116 | 114 | 114 | 110 |
| Reinforcement | | | | | |
| Property (tension | | | | | |
| product) | | | | | |
| Peeling | 100 | 110 | 108 | 109 | 110 |
| Resistance In A | | | | | |
| Humid, Heated And | | | | | |
| Aging Condition | | | | | |

As shown in Table 1, the vulcanized rubber reinforcement property of the Examples of the present invention was in a range of 110 to 116 and superior to that of Comparative Example 1. The vulcanized rubber reinforcement property of the present invention is preferably higher than that of Comparative Example 1 (the vulcanized rubber reinforcement property=100), and more preferably in a range of 105 to 170, and yet more preferably in a range of 108 to 150.

As shown in Table 1, the peeling resistance in a humid, heated and aging condition of the Examples of the present invention was in a range of 108 to 110 and superior to that of Comparative Example 1. The peeling resistance in a humid, heated and aging condition of the rubber of the present invention is preferably higher than that of Comparative Example 1 (the peeling resistance in a humid, heated and aging condition=100), and more preferably in a range of 105 to 150, and yet more preferably in a range of 106 to 130.

What is claimed is:

1: A rubber composition, comprising:
a rubber component;
a filler;
a vulcanization agent;
a vulcanization accelerator; and
a resorcinol resin,
wherein the resorcinol resin includes a cresol residue at a content of 0.2 mass % or less.

2: The rubber composition according to claim 1, wherein the vulcanization accelerator is a sulfenamide vulcanization accelerator.

3: A pneumatic tire comprising a rubber which has been obtained by vulcanizing the rubber composition according to claim 1.

4: The pneumatic tire according to claim 3, wherein the rubber is a rubber for coating steel cords.
